(19) United States
(12) Patent Application Publication
(10) Pub. No.: US 2020/0315403 A1
(43) Pub. Date: Oct. 8, 2020

(54) AUTOMATED COOKING MACHINE

(71) Applicant: Altan Robotech, Inc., Etobicoke (CA)

(72) Inventors: David D'SOUZA, Brampton (CA); Mina BASSALIOUS, Brampton (CA); Zhenqiang MI, Toronto (CA); Pritam Kumar SARKAR, Toronto (CA)

(21) Appl. No.: 16/839,695

(22) Filed: Apr. 3, 2020

Related U.S. Application Data
(60) Provisional application No. 62/829,237, filed on Apr. 4, 2019.

(51) Int. Cl. A47J 44/00; A47J 36/14; A47J 43/07; A47J 36/06; A47J 36/34; A47J 43/044; A47J 36/32

(52) U.S. Cl. CPC A47J 44/00; A47J 36/14; A47J 43/0727; A47J 43/0711; A47J 2043/0449; A47J 36/34; A47J 43/044; A47J 36/32; A47J 36/06

(57) ABSTRACT

An automated cooking machine includes a lazy susan, bowls, chopper, dispenser arm, rack with powder or liquid dispensers, heater and a pot. The automated cooking machine is controlled by a microcontroller together with sensors to cook foods with flavor like a human being. The automated cooking machine is designed in such a way so that the components that may come in contact with the food ingredients can be removed for machine wash.

### FIELD

This application is related to the field of automated cooking machine.

### INTRODUCTION

Domestic cooking is particularly time consuming, hence it is difficult for a family to get enough leisure time. On the other hand, people who depend more on restaurant food due to lack of time to cook need to spend more money on their meals. This invention may solve both problems.

### DRAWINGS

FIG. 1 is a perspective view of an automated cooking machine in accordance with an embodiment;

FIG. 2 is a centered cross-sectional view showing internal components of the automated cooking machine;

FIG. 3 is a sectional front view of a lazy susan together with a bowl;

FIG. 4 is a plan view of the lazy susan showing section line A-A for FIG. 3;

FIG. 5 is an exploded view of a tray and bowl in FIG. 3;

FIG. 6 is an exploded view of the tray in FIG. 3;

FIG. 7 is an exploded view of a coupler in FIG. 5;

FIG. 8 is a back cross-sectional view of FIG. 1;

FIG. 9 is a right cross-sectional view showing internal components of the automated cooking machine;

FIG. 10 is of FIG. 9 with the bowl tilted;

FIG. 11 is an exploded view of a chopper shown in FIG. 8;

FIG. 12 is a rack with dispenser;

FIG. 13 is an assembled view of rack with dispenser arm of FIG. 8;

FIG. 14 is an exploded view of dispenser arm;

FIG. 15 is an exploded view of rack and controller;

FIG. 16 is a perspective view of the automated cooking machine showing mounting connection with pot and heater;

FIG. 17 is an exploded view showing TDS sensor, tensiometer, pot, stirrer and lid;

FIG. 18 is an exploded view showing lid and lid arm;

### DESCRIPTION OF VARIOUS EMBODIMENTS

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant orientation relative to each other. None of the terms “coupled”, “connected”, “attached”, and “fastened” distinguish the manner in which two or more parts are joined together.

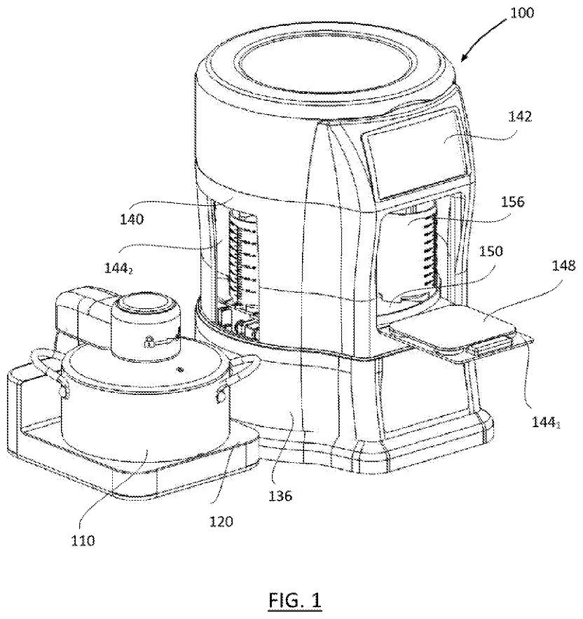

FIG. 1 illustrates the preferred embodiment of an automated cooking machine 100, capable of preparing a food autonomously. For example, automated cooking machine 100 may make simple food such as boiled egg, omelet or steamed fish or more complex food such as, but not limited to, Indian butter chicken, Chinese chow mein or Mexican chilli con carne. The food dishes may be selected from the display panel 142 or via a mobile application using phone and once selected, the corresponding recipe may be automatically displayed on the display panel 142. Automated cooking machine may direct the cooking procedure by voice instructions too, if it is turned on. In this case, voice instruction may communicate with the user interactively giving an instruction to and getting the response from the user and then, proceed to the next instruction. This may help user to operate the machine in a more friendly manner.

Still referring to FIG. 1, automated cooking machine 100 has an outer jacket 136 and a housing 140, the housing 140 is residing inside and connected to outer jacket 136. The housing 140 is manually movable along a perpendicular direction with respect to base of outer jacket 136. This provides user to maneuver the height of the automated cooking machine 100 and the user may set the height accordingly. Housing 140 encircles the automatic cooking machine externally, however, housing 140 has a front window 144₁ that may be opened or closed manually by user. Voice instructor may guide user to feed the ingredients through window 144₁ methodically one at a time. User may follow the instructions and once done, close window 144₁ and press the start button. Automated cooking machine 100 takes over thereon to cook the dish without any further manual intervention. User may disable the voice instruction, however, in this case, user needs to feed manually all the ingredients which are required to cook the dish selected.

Still referring to FIG. 1, automated cooking machine 100 has side windows too. The raw ingredients that are to be cooked may be weighed on a weighing scale 148 and fed through the front window 144₁ inside the machine. The weighing scale 148 may be connected to the front window 144₁ in such a manner so that when the user opens window 144₁ the weighing scale 148 comes down along with the window 144₁ right in front of the user. This helps user to weigh the ingredients conveniently. Automated cooking machine 100 chops the solid ingredients as required, adds and mixes the common spices and liquid ingredients autonomously as required, in a planned systematic manner and transfer the ingredients through a side window 144₂ to a cooking pot 110 wherein the ingredients are cooked. Automated cooking machine 100 maintains time, cooking status, sequence of ingredients to be transferred to the cooking pot 110 like an expert human chef. Automated cooking machine 100 carries out all the cooking arrangements autonomously inside the machine and cooks the ingredients in cooking pot 110 autonomously too, heats the cooking pot by a heater 120 and informs the user when the food is ready. Automated cooking machine has another side window 144₃ (not in FIG. 1) which is across window 144₂ and may be used to clean the inside of the machine or bring some dismantlable accessories out of the machine for washing purpose.

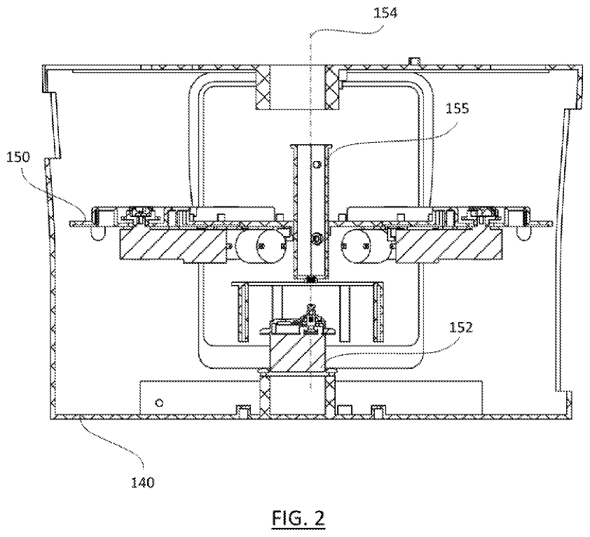

Reference is now made to FIG. 2, wherein a lazy susan 150 is shown. An actuator 152 may drive the lazy susan 150. There is a simple transmission which comprises a hexagonal pipe 155 connected to actuator 152 transmitting power from actuator 152 to lazy susan 150. The transmission may be similar to any other power transmitter such as, but not limited to, gear box, chain sprocket, or belt pulley. The lazy susan 150 has a compatible shaped hole at the center so that the hexagonal pipe 155 may pass through the hole and maintains snug fit with the lazy susan 150. The distal end of the hexagonal pipe 155 connects to actuator 152 and is driven. As the actuator 152 rotates, the hexagonal pipe 155 also rotates thereby rotating the lazy susan 150 about an axis 154. The velocity as well as position of actuator 152 may be monitored and controlled as required to position the lazy susan 150 at any desired location.

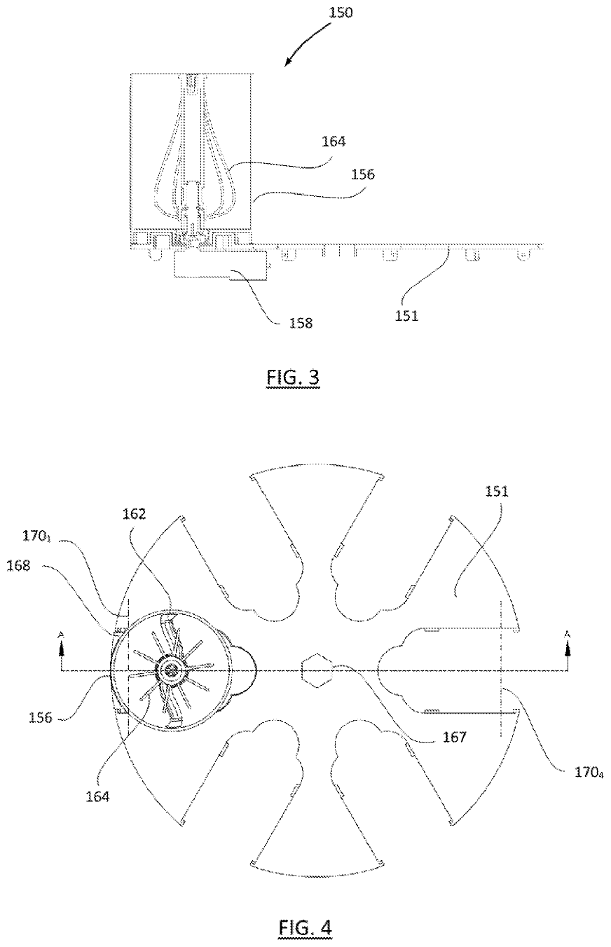

FIG. 3 is a sectional view of FIG. 4 where the line of section is shown as A-A. Referring to FIGS. 3-4, lazy susan 150 may have a platform 151 and at least one tray 168. There may be multiple trays depending on a specific design; for example, the present design has six trays that may be connected to platform 151. The location where the tray 168 is connected is shown in FIG. 4 as a central dashed line 170 about which tray 168 can be swiveled. Axis 170 is the line of connection between tray 168 and platform 151. Tray 168 comprises a bowl 156, a stirrer 162, and an actuator 158 for rotating the said stirrer 162. Bowl 156 comprises a whisker blade 164 for whisking the ingredients and is removably replaceable by another tool for example a chopping blade. At the center of platform 151, a hexagonal hole 167 allows hexagonal pipe 155 to pass through and connect actuator 152 as explained before. Turning to FIG. 4, wherein it has been shown that the total number of bowl(s) 156, lazy susan 150 has, is equal to six. While lazy susan 150 may have any number of bowl(s), FIG. 4 shows six for this specific design only.

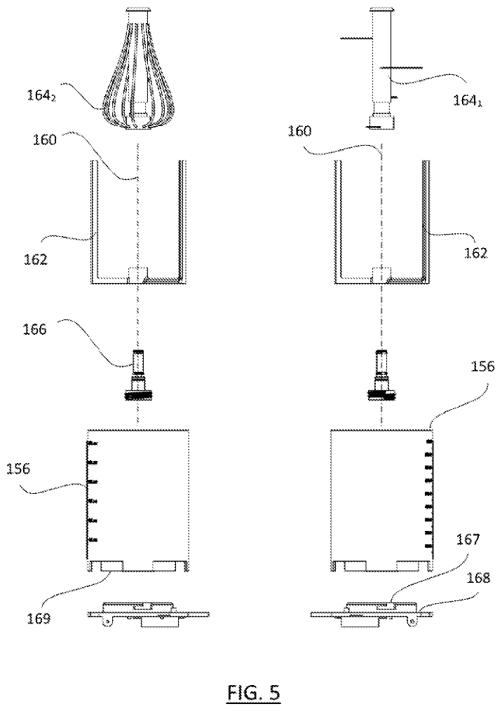

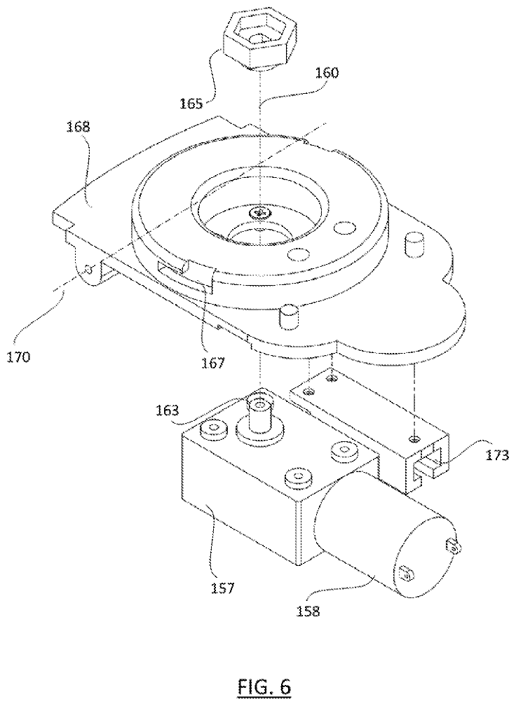

An exploded view of tray 168 and bowl 156 are shown in FIGS. 5-6. Bowl 156 may be connected to tray 168 using a mount 167 on tray 168 and a connector 169 available at the bottom of bowl 156. Connector 169 may be properly aligned at first with the mount 167 and once it is done, the bowl 156 may be inserted into the mount 167 by pressing down. Once connector 169 is inserted into the mount 167, bowl 156 may be rotated clockwise to lock the bowl 156 onto the tray 168.

Still referring to FIGS. 5-6, wherein actuator 158 that drives stirrer 162 may be connected to a power transmitter 157. Power transmitter 157 is permanently fixed onto tray 168 from the bottom of the said tray 168. The distal end of the shaft 163 coming out of power transmitter 157 is permanently connected to a nut shaped connector 165. There is no connection between shaft 163 and tray 168. As a result, when actuator 158 energizes, the power is transmitted from the actuator 158 to the connector 165 rotating the connector 165 about an axis 160. This rotation is transmitted to stirrer 162 through a coupler 166 which has a hexagonal base connects connector 165 to stirrer 162. Connector 165 has a hexagonal seat that may connect the matching hexagon base of coupler 166 with snug fit arrangement. Referring to FIG. 6, wherein a slotted box 173 is shown, slotted box 173 is permanently connected to tray 168 helping the tray to swivel about axis 170.

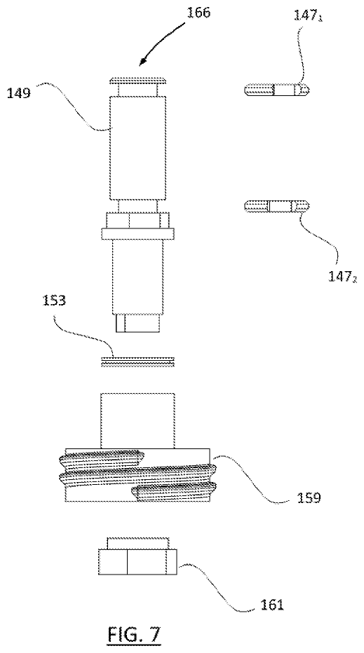

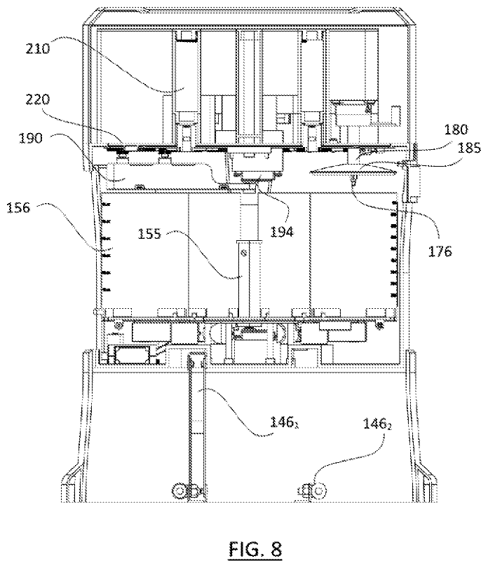

Reference is now made to FIG. 7, wherein an exploded view of coupler 166 is shown. Coupler 166 comprises four components—top part 149, gasket 153, bottom part 159 and a hexagonal nut 161. Bottom part 159 is permanently connected to bowl 156 using the thread. Gasket 153 rests on the top of bottom part 159 and top part 149 may rest on gasket 153. The distal end of top part 149 may go through the inner groove of the bottom part 159 and is permanently connected to hexagonal nut 161. There is no connection between top part 149 and bottom part 159. As a result, top part 149 may freely rotate within bottom part 159 when hexagonal nut 161 rotates. Stirrer 162 is removably connectable to top part 149 using hexagonal mating. This also helps transferring motion from top part 149 to stirrer 162.

Still referring to FIG. 7, there are split rings 147₁ and 147₂ that may be used on top part 149. When chopping blade or whisker 164 rests on the top part 149, the split rings prevent the chopping blade or whisker 164 to get detached from the top part 149 easily unless a detachment force is applied. This also prevents the chopping blade or whisker 164 to drop down when the bowl 156 with the chopping blade or whisker 164 becomes upside down. The actuator that drives the chopping blade or whisker 164 comes from the top and gets engaged with the chopping blade or whisker 164 at the frontal end. The distal end of chopping blade or whisker rests on the coupler 166 and capable of rotating freely about axis 160.

Referring again to FIGS. 5-6, actuator(s) 158 may run simultaneously in unison with lazy susan 150 or individually or any combination thereof. Bowl 156 has a chopping blade (or whisker) 164 too, capable of chopping raw solid ingredients, for example, potato, onion, or garlic inside bowl 156. Chopping blade 164 is selectable in size and shape that depends on the required chopped style of the ingredients. While one end of chopping blade 164 rests at the bottom of bowl 156, the other end is free. Chopping blade 164 is rotatable about vertical axis 160 and engageable at the free end. Stirrer 162 and chopping blade 164 may rotate simultaneously; however, chopping blade 164 never runs in unison with lazy susan 150.

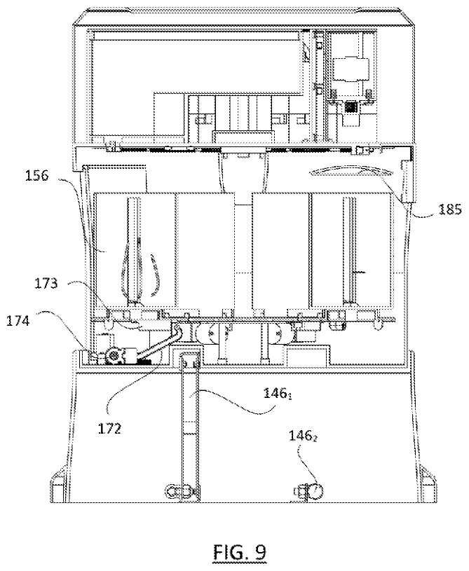

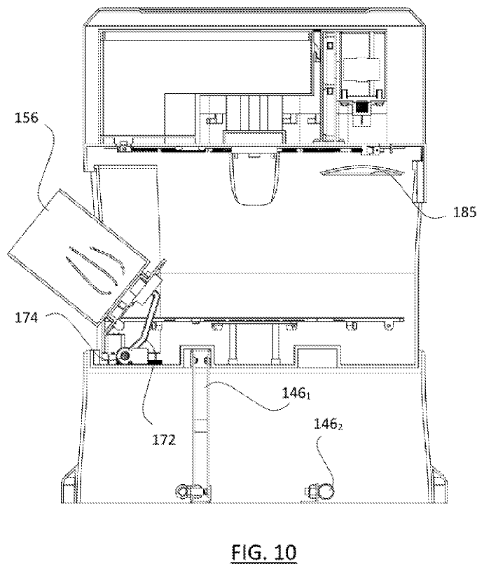

FIGS. 8-10 illustrates another embodiment of automated cooking machine 100 that includes a flipper arm 172, a chopper 180 having a lid 185, a dispenser arm 190, a removably connectable dispenser rack(s) 220 and a removably connectable spice or liquid dispenser(s) 210. Flipper arm 172 may latch onto slotted box 173 of tray 168 and rotate as shown in FIGS. 9-10 by an actuator 174 in both clockwise and anticlockwise directions. This helps flipper arm 172 to flip bowl 156 and brings bowl 156 back. FIG. 10 also shows other position while flipping bowl 156. During flipping, bowl 156 discharges ingredients into pot 110 (not in figure) wherein the cooking process may take place, a rotational motion of stirrer 162 accelerates the discharge process emptying the bowl 156 fully. Every time a bowl 156 needs to be discharged, lazy susan 150 needs to be rotated bringing the said bowl 156 to a specific location wherein the flipper arm 172 may latch onto slotted box 173.

Still referring to FIG. 8, dispenser rack 220 may be connected or placed at the roof of automated cooking machine 100. The height of automated cooking machine may be adjusted manually using slider link mechanism 146₁ and 146₂. Automatic cooking machine 100 uses bowl(s) 156 to preprocess the ingredients. For example, if any mixing is required before cooking automated cooking machine 100 may put the spices to be mixed in one bowl 156 and then, stir by rotating the stirrer inside the said bowl 156. If chopping is required automated cooking machine may chop the ingredient inside bowl 156. Depending on the dish to be cooked and the recipe chosen, automated cooking machine 100 takes required action automatically and autonomously.

Continuing the reference to FIG. 8, an omnidirectional camera may be placed on top of body looking straight vertically up so that it may take picture of the surroundings. The camera may see all the spice and liquid dispenser(s) and a narrow sliver on the surface of each dispenser 210. Then, the camera may analyze the contrast between the present and an empty dispenser and predict when the dispenser needs to be filled again. The camera may send signal to the user to let him know which dispenser needs to be filled in. The camera may also be able to see in infrared as to obtain a better contrast where clear liquids are used.

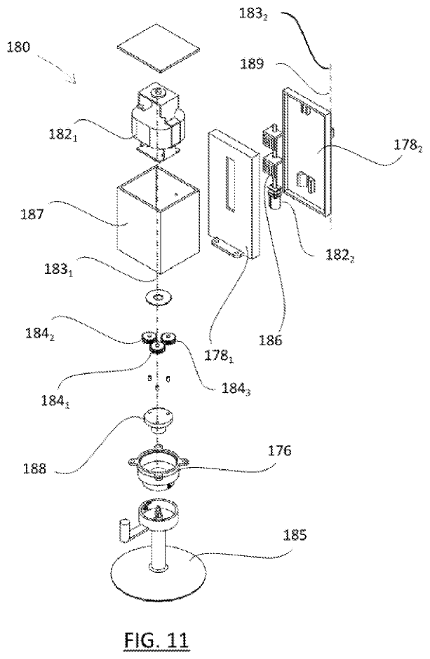

FIG. 11 shows an exploded view of chopper 180, wherein at least two actuators are used. First actuator 182₁ provides the rotational motion of chopping blade or whisker 164 about an axis 183₁ and second actuator 182₂ provides the rotational motion of a screw 189 about an axis 183₂. On screw 189, there is a block 186 and both screw 189 and block 186 are housed inside a housing 178 such that block 186 may translate along a slot on housing 178₁ as shown in FIG. 11. Block 186 is coupled to actuator 182₁ which is housed inside housing 187. Housing 187 is permanently connected to housing 178. Actuator 182₁ may translate along with block 186 when block 186 translates linearly. Actuator 182₁ may drive a sun gear (not shown) coupled to its shaft. This sun gear when rotates transfers rotary motion to planetary gear(s) 184 which are connected to a carrier 188 thereby transferring rotational motion to carrier 188. Therefore, carrier 188 translates along axis 183₁ thereby reaching to and engaging with the open end of chopping blade (or whisker) 164. Planetary gear 184 and carrier 188 are housed inside a housing 176 which is again connected to the actuator housing. Lid 185 is connected to housing 176 too and may close bowl 156 when carrier 188 engages chopping blade (or whisker) 164. There is no connection between carrier 188 and housing 176. This allows the rotary motion of actuator 1821 to get transferred to carrier 188 and then to chopping blade (or whisker) 164 without interference.

The positioning of chopping blade 164 may be carried out by actuator 152 driving and controlling lazy susan 150 so that the bowl 156 where the ingredients to be chopped comes to a position exactly beneath the chopper 180. In other words, axis 160 matches axis 183₁. When chopper engages chopping blade, lid 185 may close bowl 156 preventing spillage of ingredients while chopping. When actuator 182₁ rotates chopping blade about axis 183₁, chopping blade 164 chops the ingredients inside the bowl. Chopping blade may be replaced by a whisker or other types of tool that adds performance requirement of pre-cooking process.

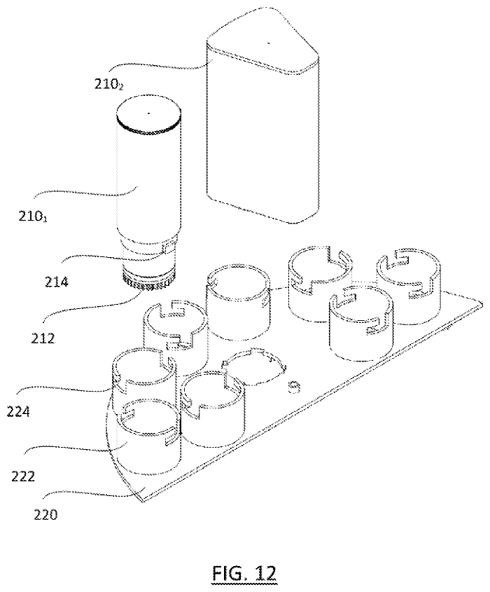

Referring to FIG. 12, rack 220 comprises holder 222 in plurality and holds spice dispenser 2101 or liquid dispenser 2102 onto holder(s) 222. Each holder 222 is hollow cylindrical in shape so that dispenser may pass through the circular hole of rack 220. Each holder 222 has a L-shaped mounting slot 224 too. Each dispenser 210 has two such slots 180° apart. Dispenser 210 may have a motion transmission gear 212 at the distal end that may induce self-rotary motion inside dispenser 210. Dispenser 210 has connector 214 that may be aligned with mounting slot 224. Once aligned, dispenser 210 may be pressed down and rotated clockwise manually thereby locking the dispenser to holder 222. The design of connector 214 is such that when dispenser 210 is locked, gear 212 is below base plane of rack 220 and is parallel to the base plane too.

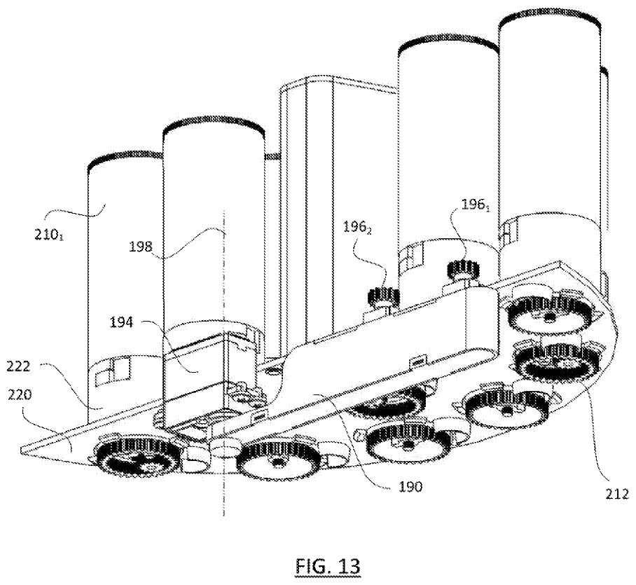

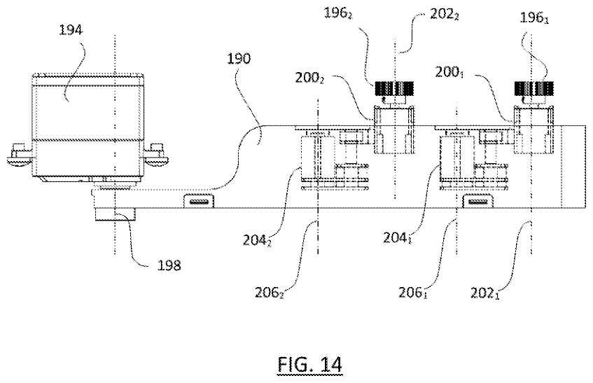

Reference is now made to FIGS. 13-14, wherein rack 220 holding dispenser(s) 210 is shown. Dispenser(s) 210 may contain spice or liquid and is connected to holder(s) 222 which may be equally spaced along a circular periphery. There may be multiple concentric peripheries to hold many spice and liquid dispenser(s) 210. The center of the periphery holds one end of dispenser arm 190 which may be used to dispense spice or liquid ingredients by coupling the other end to spice or liquid dispenser 210 via gear 212. Dispenser arm 190 that is used to dispense spice or liquid is not connected to dispensing rack 220. The frontal end of dispenser arm 190 is pivoted, wherein an actuator 194 may rotate dispenser arm 190 about a pivot axis 198. The distal end of dispenser arm 190 is such that the distal end can reach the farthest periphery where the spice or liquid dispenser 210 is available. At the distal end, an actuator 200₁ drives a gear 196₁ about an axis 202₁. Actuator 200₁ and gear 196₁ form a set that may be driven linearly along an axis 202₁ by an actuator 204₁ rotating about an axis 206₁. Depending on single or multiple peripheries of holder(s) 222 on rack 220, dispenser arm 190 may have single or multiple sets, wherein each set comprises actuator 200, gear 196 and actuator 204 with motion transmission from rotary to linear. For example, FIG. 14 shows multiple sets wherein a second set is shown at the middle of dispenser arm 190.

Still referring to FIG. 13-14, there is another actuator 200₂ that drives another gear 196₂ about an axis 202₂ forming a second set that may be driven linearly too along an axis 202₂ by another actuator 204₂ rotating about an axis 206₂. Actuator 194 drives dispenser arm 190 thereby positions distal end either gear 196₁ or 196₂ to engage a specific spice or liquid dispenser 210 via gear 212. Depending on which gear needs to be positioned, the corresponding set is driven linearly toward the specific dispenser 210 engaging gear 212 of the said dispenser 210 as shown in FIG. 13. Once, dispenser gear 212 is engaged, either actuator 200₁ or 200₂ is activated rotating the dispenser gear 212 accordingly about an axis either 202₁ or 202₂ respectively, thereby dispensing a measured amount of spice or liquid depending on which type of dispenser the set is engaged upon. The measurement or amount of discharge may be obtained by the measurement of number of rotations of gear 212. Dispenser 210₁ may have powder spice, solid spice. Dispenser 210₁ that has solid spice has grinder that is connected to gear 212. Hence, when gear 212 rotates it rotates grinder too crushing solid spice or liquid during dispensing. While all motions are transferred through gears, there may be other kinds of transmission such as, but not limited to, belt pulley, chain sprocket and so on.

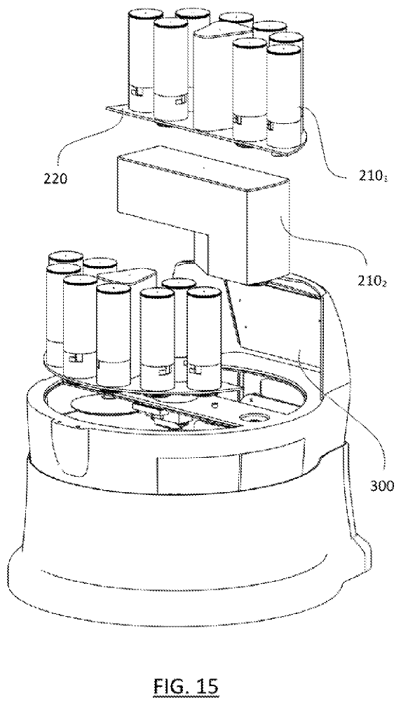

Reference is now made to FIG. 15, wherein automated cooking machine 100 includes a microcontroller 300 that, together with software program and sensors, may control automated cooking machine 100. Microcontroller 300 has a user interface in the form of display panel 142. User may select dish to be cooked using display panel 142 or via a mobile application and display panel 142 may display recipes and directions of cooking the dish using automated cooking machine 100. The user may follow the directions, for example, the user may be directed to weigh the raw ingredients on weighing machine 148 one at a time and put the ingredient inside a specific bowl 156 memorized by microcontroller 300. This way microcontroller 300 knows which bowl has what kind of ingredient. Once the raw ingredients are fed into the bowls, the user may close the window and automated cooking machine takes over thereon and do the rest of the cooking for the user. If any chopping is required for that dish to be cooked, microcontroller 300 may rotate lazy susan 150 to bring the specific bowl 156, where the ingredient to be chopped is kept, to a specific location under the chopper and direct chopper 180 (FIG. 8) to do the chopping. Microcontroller 300 may send command to actuator(s) 182 to move chopper 180 engaging chopping blade 164 and chop the ingredient by rotating the said chopping blade 164.

Still referring to FIG. 15, microcontroller 300 knows the recipes and the time when to add which ingredient during the cooking process, hence may add raw ingredients, specific spices and liquid ingredients accordingly into the bowls. Microcontroller 300 may use dispenser arm 190 to dispense spice and liquid ingredients into bowl 156. Microcontroller 300 may communicate another microcontroller to supervise the cooking process from start to finish.

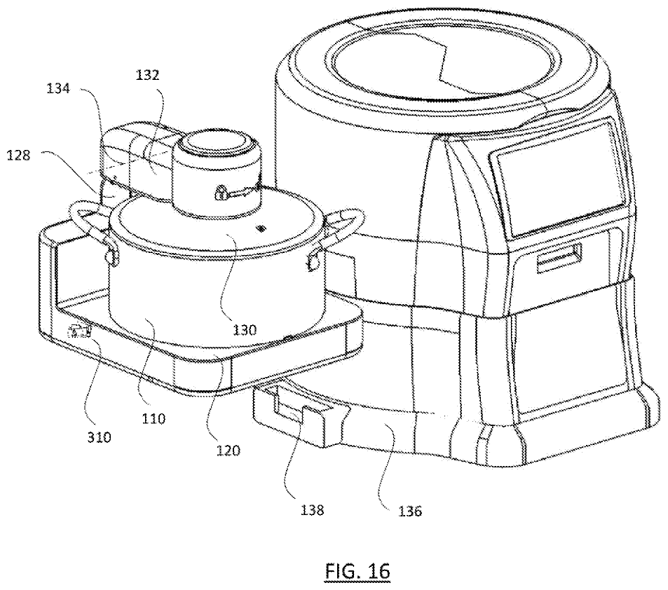

Turning to FIG. 16, automated cooking machine 100 may be connected to heater 120. Heater 120 may be induction heater or any other type and may be connected to base of outer jacket 136 in various ways. For example, outer jacket 136 may have seat 138 and heater 120 may have a connector that may go straight into seat 138. The connection is not just mechanical but electrical too as microcontroller 300 communicates to the control unit of heater and pot unit for exchanging parameter data between them. Before starting the machine, the user must engage heater 120 to outer jacket 136 and place the cooking pot 110 on the heater 120 as shown in FIG. 16 for precautionary measure. This connection also provides stability of the cooking pot 110 while automated cooking machine 100 is in operation. If the user may use heater 120 and cooking pot 110 as an independent unit. In this case, the user may cook the food manually like any other stove and pot.

Still referring to FIG. 16, automated cooking machine may include a lid 130 that can open or close pot 110. Lid 130 may include a lid arm 132 that may be rotated about a pivot axis 134 thereby opening or closing pot 110. It is again microcontroller 300 that decides when to open and when to close during the cooking process. Lid arm 132 is connected to a structure 128 that is in turn connected to heater 120. A microcontroller 310 may communicate to microcontroller 300 that may control time while cooking as microcontroller 300 starts cooking adding ingredients sequentially from bowl(s) into pot 110. Microcontroller 310 may control energy input to heater 120 for maintaining the temperature inside pot 110 as required. Microcontroller 310 may initiate stirring, opening or closing lid 130 as and when required while cooking. Once the dish is cooked microcontroller 300 may send signal to the user to let him know that the dish is done. This way microcontroller 300 may cook food autonomously without any human intervention once the cooking process is started.

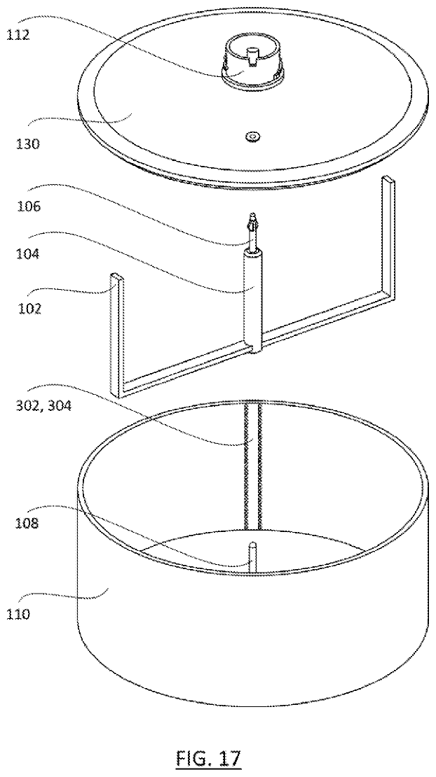

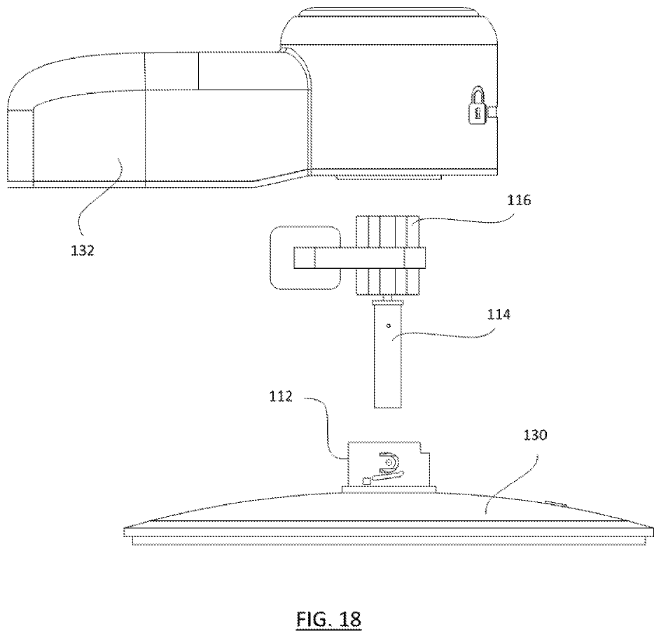

Reference is now made to FIGS. 17-18, wherein pot 110, stirrer 102, an exploded view of lid arm 132 and lid 130 are shown. Stirrer 102 includes a shaft 104 at the middle. Shaft 104 may have circular slot that may straight go into a solid shaft 108 which is at the center of pot 110. This facilitates easy removal of stirrer for cleaning purpose. There is a coupler 106 at the tip of shaft 104 for engaging with another mating coupler 114. Lid 130 includes a cap 112 that, together with lid arm 132, may house an actuator 116 connected with coupler 114. When lid arm rotates to close pot 110 coupler 114 may engage with coupler 106 so that actuator 116 can rotate stirrer 102.

Still referring to FIG. 17, pot 110 may comprise an array of parallel TDS sensors 302. The advantages of using these sensors are two folds. The first being as a mechanism to measure continuously the total dissolved solids in the food during cooking. This way, microcontroller 300 may know how the salinity changes inside pot 110 as various ingredients are added to said pot 110. Microcontroller 300 may compare the sensor data with a reference value already stored in the system and take appropriate action. For example, the action may be to add salt to increase salinity or add lime thereby reducing some effect of salinity but adding sour taste and flavor. The action, whatsoever microcontroller 300 takes for a specific problem, is not arbitrary in nature but, may be derived from an expert algorithm inbuilt in the system. This makes pot 110 smarter and adaptable to cooking environment. Secondly, cooking ingredients are solid, liquid and powder. While solid stays at the bottom, powder either dissolves in liquid or mixes with both liquid and solid, and liquid takes the shape of pot 110 and fills from the bottom. Therefore, microcontroller 300 may compare sensor data between different layers and predict height of the solid ingredients and the top layer—both from the bottom of pot 110. From these heights, microcontroller 300 may initiate other actions such as, but not limited to, adding water, stirring ingredients in pot 110, increasing or decreasing temperature and so on. This way, microcontroller 300 may control cooking environment adaptably using parameters and sensor data to cook food properly, smartly and tasty.

Still referring to FIG. 17, pot 110 may comprise a tensiometer 304 to measure the matric water potential at this level where the water is about to dry up. Tensiometer 304 may comprise a tube that contains fluid and a partial vacuum, tipped with a porous ceramic (permeable to fluid) at near end to the fluid inside pot 110 and a sealed pressure gauge with a signal output proportional to the vacuum pressure inside the tube, at the far end so that as fluid is drawn out of the tube due to evaporation in the pot, the signal amplitude changes proportionately with the increasing vacuum inside the tube. And when fluid is drawn into the tube by a surplus of water in the pot, the signal amplitude changes proportionately with the decreasing vacuum inside the tube. In this way, the matric water potential of the food, and an appropriate amount of water to be added to the food, may be determined by controller 300.

1. An automated cooking machine for preparing, dispensing and making food automatically, the automated cooking machine comprising:
an outer jacket; and
a height adjustable housing, residing inside and coupled to the outer jacket, wherein the outer jacket is fixed, is movable parallelly towards or away from the outer jacket and the said housing comprises:
a lazy susan being driven by an actuator mounted on the housing, the lazy susan may rotate about a vertical axis passing through the center of the lazy susan positioning the lazy susan at any desired location;
a dispenser arm above the lazy susan for dispensing powder spices and liquid cooking ingredients;
an actuator for rotating the dispenser arm, wherein the actuator is coupled to the first distal end of the dispenser arm, the second distal end may rotate about the first distal end positioning the second distal end at any desired location along the trajectory of the second distal end;
a chopper above the lazy susan for chopping or whisking solid ingredients;
an actuator for driving the chopper toward the lazy susan or away from the lazy susan; and
a flipper driven by an actuator for flipping the bowl.

2. The automated cooking machine of claim 1, wherein the lazy susan comprises:
a rotatable platform;
a plurality of trays;
a mount securable to the platform; and
a connector coupled to the tray and removably connectable to the platform such that the tray may rotate about an axis joining the points of connection.

3. The automated cooking machine of claim 2, wherein the tray comprises:
a bowl for carrying the solid ingredients which may be chopped or whisked inside the bowl;
a stirrer;
an actuator for rotating the stirrer, the actuator is mounted securely on the tray;
a mount securable to the tray;
a connector coupled to the bowl and removably connectable to the tray;
a mount securable to the actuator; and
a connector coupled to the stirrer and removably connectable to the actuator.

4. The automated cooking machine of claim 3, wherein the bowl comprises:
a removably connectable blade for chopping or whisking solid ingredients, wherein the first distal end sits freely at the bottom center of the bowl concentrically, restraining any linear movement such that the blade, if driven at the second distal end, may rotate about the concentric central axis of the blade.

5. (canceled)

6. The automated cooking machine of claim 1, wherein the housing further comprises:
a plurality of racks above the dispenser arm removably connectable to the housing;
a plurality of mounts securable to each rack;
a plurality of ingredient dispensers removably connectable to the rack, wherein at least one ingredient dispenser is either solid ingredient dispenser or liquid ingredient dispenser or powder ingredient dispenser;
an actuator;
a rotatable camera driven by the actuator; and
a plurality of lamps.

7. The automated cooking machine of claim 6, wherein the ingredient dispenser comprises:
a connector coupled to the ingredient dispenser; and
an engageable coupler.

8. (canceled)

9. The automated cooking machine of claim 6, wherein the camera may detect light from the lamp if the dispenser is empty or the level is below a certain level thereby detecting the need to refill the said dispenser.

10. The automated cooking machine of claim 1, wherein the dispenser arm comprises:
one or more pair of actuators, the first actuator in each pair securely mounted on the dispenser arm may drive the second actuator either away from or towards the dispenser arm linearly along an axis perpendicular to the dispenser arm; and
a coupler coupled to the second actuator, the coupler moves along with the second actuator and may be positioned at any desired location by activating the first actuator.

11. The automated cooking machine of claim 10, wherein the coupler of the dispenser arm may be engaged to or dis-engaged from the engageable coupler of the ingredient dispenser.

12. The automated cooking machine of claim 11, wherein once the said coupler engages the engageable coupler of a solid or powder dispenser, the second actuator of the dispenser arm rotates thereby discharging powder ingredient from the solid or powder ingredient dispenser.

13. The automated cooking machine of claim 12, wherein the second actuator may rotate an estimated number of rotations discharging a measured quantity of powder ingredient.

14. (canceled)

15. (canceled)

16. The automated cooking machine of claim 1, wherein the chopper comprises:
a spindle;
an actuator to rotate the spindle;
an engageable and dis-engageable connector at the free end of the spindle for coupling the spindle to the blade; and
a lid above the connector for closing the bowl.

17. The automated cooking machine of claim 4, wherein the bowl may hold solid ingredient and the chopping or whisking of the solid ingredient may be done inside the bowl by connecting the blade with the spindle of the chopper.

18. The automated cooking machine of claim 16, wherein the spindle may descend engaging the connector to the connector of the blade right under the spindle.

19. The automated cooking machine of claim 16, wherein the lid of the chopper closes the bowl when the spindle engages the blade.

20. (canceled)

21. The automated cooking machine of claim 1, wherein the housing further comprising:
one or more openable and closable window; and
a weighing scale.

22. (canceled)

23. The automated cooking machine of claim 22, wherein opening the front window brings the weighing scale in front of the user.

24. The automated cooking machine of claim 22, wherein opening the front window allows the user to engage or disengage the bowl.

25. (canceled)

26. (canceled)

27. (canceled)

28. The automated cooking machine of claim 1, wherein the first distal end of the flipper is connected to the actuator and the second distal end may be rotated for latching onto the tray at a latch point.

29. The automated cooking machine of claim 28, wherein the latch point is such that any further rotation of the flipper may result in a rotation of the tray about the tray's axis of rotation thereby flipping the bowl too along with the tray.

30-41. (canceled)
